(19) United States
(12) Patent Application Publication
(10) Pub. No.: US 2025/0044316 A1
(43) Pub. Date: Feb. 6, 2025

(54) REPROCESSING LIQUID FEED SYSTEM AND METHOD FOR DOSING A PREDETERMINED AMOUNT OF REPROCESSING LIQUID ONTO A TEST SURFACE OF A TEST STRIP

(71) Applicant: OLYMPUS WINTER & IBE GMBH, Hamburg (DE)

(72) Inventors: Alexander Werner, Bielefeld (DE); Martin Schnieders, Bielefeld (DE); Celina Werner, Bochum (DE); Gregor Goldberg, Warendorf (DE)

(73) Assignee: OLYMPUS WINTER & IBE GMBH, Hamburg (DE)

(21) Appl. No.: 18/792,878

(22) Filed: Aug. 2, 2024

Related U.S. Application Data
(60) Provisional application No. 63/530,504, filed on Aug. 3, 2023.

(51) Int. Cl. G01N 35/10

(52) U.S. Cl. CPC G01N 35/1097

(57) ABSTRACT

A reprocessing liquid feed system for dosing a predetermined amount of reprocessing liquid onto a test surface of a test strip including: a first directional control valve having two valve inlets and one valve outlet; and a second directional control valve having one valve inlet and two valve outlets for filling a specified volume with reprocessing liquid; filling the specified volume containing reprocessing liquid partially with air such that the specified volume is filled partially with remaining reprocessing liquid and partially with air; and dosing out the remaining reprocessing liquid in the specified volume onto the test surface of the test strip.

### CROSS-REFERENCE TO RELATED APPLICATION

The present application is based upon and claims the benefit of priority from U.S. Provisional Application No. 63/530,504 filed on Aug. 3, 2023, the entire contents of which is incorporated herein by reference.

The present application is related to the following co-pending U.S, Applications, each filed on Aug. 2, 2024, U.S. patent application Ser. No. 18/______ (corresponding to U.S. Provisional Patent Application 63/530,490); U.S. patent application Ser. No. 18/______ (corresponding to U.S. Provisional Patent Application 63/530,492); U.S. patent application Ser. No. 18/______ (corresponding to U.S. Provisional Patent Application 63/530,496); and U.S. patent application Ser. No. 18/______ (corresponding to U.S. Provisional Patent Application 63/530,500); the entire contents of each of which is incorporated herein by reference.

### BACKGROUND

### Field

The present disclosure relates to a reprocessing liquid feed system for dosing a predetermined amount of reprocessing liquid onto a test surface of a test strip, an arrangement for measuring a concentration of reprocessing agents in a reprocessing liquid used in a reprocessing apparatus for medical instruments, a reprocessing apparatus for medical instruments, method for dosing a predetermined amount of reprocessing liquid onto a test surface of a test strip, and method for reprocessing medical instruments.

### Prior Art

Test strips are often used in analysis units for detecting cleaning, sterilization and/or disinfection agents, for example for measuring a concentration of reprocessing agents. Such analysis units may be used, for example, in water-bearing household appliances are known, for example, from DE 102009027950 A1. This document relates to a household device having a control device for performing rinse cycles, which are adjusted by the control device using cleaning agents e.g. additives. An analyzing unit detects the cleaning agents and is provided with a reading unit for radio frequency identification of barcode or other identification marks printed on the cleaning agents. The analyzing unit is connected with the control device for transmitting analyzing data from the analyzing unit to the control unit.

Furthermore, EP 3302210 B1 discloses a device and a method for determining the composition of the dirt load in a rinsing or detergent solution in a water-using household appliance, for example in a dishwasher, using near infrared spectroscopy (NIR).

Patent application DE 19806559 B4 discloses a method involving emitting rays into a dish stack, determining and/or recording a quantity or rays of at least one wavelength range, leaving the stack under respectively one predetermined angle, assuming a kind and a concentration of a pollution ratio and/or a cleaner ratio of the dish stack, and optimizing a dish washer program, accordingly. A corresponding dish washer arrangement is also disclosed.

Patent application DE 102007011119 A1 relates to a washing machine with an automatic controller for washing process and optical sensor devices. The optical sensor devices transmit signals, which are evaluated for controlling the washing process. The optical sensor devices detect light intensities of different spectral regions. The optical sensor devices are sensitive over the entire spectral region from infrared to ultraviolet. The optical sensor devices are arranged at a bypass such that the optical sensor devices measure characteristics of detergent components in different positions.

Existing solutions for measuring a concentration of reprocessing agents, however, usually are comparatively expensive and often require the use of specialized chemicals. Further, existing solutions are often operated fully or partly manually and/or are not always accurate and robust against operating errors. For example, existing solutions for dosing liquids to be measured onto test strips are often too costly and/or not suitable, reliable or accurate enough for specific areas of application.

### SUMMARY

Therefore, an object is to provide a solution, which reduces or eliminates one or more of the above-mentioned disadvantages. For example, an object is to provide an improved liquid feed system for dosing a predetermined amount of reprocessing liquid onto a test surface of a test strip and an improved method for dosing a predetermined amount of reprocessing liquid onto a test surface of a test strip, which are reliable, accurate, cost-efficient, and less sensitive to operation errors.

According to a first embodiment, a reprocessing liquid feed system for dosing a predetermined amount of reprocessing liquid onto a test surface of a test strip is provided, the reprocessing liquid feed system comprising a first directional control valve having two valve inlets and one valve outlet; a second directional control valve having one valve inlet and two valve outlets; wherein one of the two valve inlets of the first directional control valve is connected to a first conduit for a hydraulic connection of a measuring system with a reprocessing circuit of a reprocessing apparatus and the other one of the two valve inlets of the first directional control valve is connected to a compressed air line connected to a compressed air supply and the valve outlet of the first directional control valve is connected to the valve inlet of the second directional control valve; wherein one of the two valve outlets of the second directional control valve is connected to a second conduit for a bypass connection of the measuring system back into a reprocessing chamber of the reprocessing apparatus and the other one of the two valve outlets of the second directional control valve is connected to a sample feed line for dosing a predetermined amount of reprocessing liquid onto a test surface of a test strip; and wherein between the first and the second directional control valves a specified volume is predetermined.

In the following, initially the reprocessing liquid feed system and its components, functions and embodiments will be described.

Reprocessing as used herein may comprise all steps necessary to reuse previously used medical instruments, including removing blood, tissue and other biological debris and inactivating infectious microorganisms and/or viruses. For example, reprocessing may encompass, but is not limited to, initial basic and subsequent thorough cleaning, and/or disinfecting, and/or sterilizing the medical instruments using suitable cleaning, and/or disinfecting, and/or sterilizing agents. Reprocessing may also encompass re-packaging and of terminally sterilizing the previously cleaned, and/or disinfected, and/or sterilized medical instruments. Reprocessing agents may comprise reprocessing chemicals, for example peracetic acids. A reprocessing cycle may encompass a procedure, carried out, for example, in a reprocessing apparatus, used to reprocess a medical instrument between two uses. A reprocessing cycle may encompass a process of cleaning and/or rinsing and/or disinfection and/or sterilization.

Medical instruments as used herein encompass endoscopes and/or probes, for example, and further specified reusable medical instruments, such as reusable endoscopes and/or reusable probes.

The reprocessing of medical instruments is particularly sensitive for the safety of medical procedures using such medical instruments and thus highest requirements for the reliability of such reprocessing apply. For example, the requirements in reprocessing medical instruments differ from and exceed those for water-bearing household appliances, such as dishwashers and washing machines, by far and significantly. Therefore, solutions for such water-bearing household appliances are not suitable or sufficient for the requirements applying to the reprocessing of medical instruments between different medical procedures on different patients.

The reprocessing liquid feed system provided herein considers that the accuracy and reliability of the process of dosing liquid onto the test surface significantly influences the accuracy and reliability of the measurement results. For example, it is important to reliably dose an accurate, predetermined amount of reprocessing liquid onto the test surface. To achieve this and other advantages, the reprocessing liquid feed system defines a specified volume, which is connected to a sample feed line through which liquid contained in the specified volume can be dosed onto the test surface of a test strip.

The specified volume can be filled with reprocessing liquid and emptied towards the sample feed line via the first and second directional control valves and a compressed air supply connected thereto. The specified volume may be in the form of a vessel, container or tube, for example. Providing a specified volume connected to the first and second directional control valves, it is easy to fill the specified volume with reprocessing liquid and to dose exactly a required amount contained in the specified volume to the test surface. Thus, the dosing is much more reliable and accurate.

The reprocessing liquid feed system can be in liquid connection with a bypass circuit of a reprocessing circuit. A bypass liquid connection or bypass circuit for reprocessing liquid can be provided by the first and second conduits, along which a measuring system can be positioned, which uses test strips.

The sample feed line and/or the reprocessing liquid feed system may be part of arrangement for measuring a concentration of reprocessing agents in a reprocessing liquid.

In the following, embodiments are described relating to preferred states of the reprocessing liquid feed system and for example its first and second directional control valves, which can be used during operation of the reprocessing liquid feed system.

According to an embodiment, in a first, flow-through state, the first and the second directional control valves are not activated and a liquid connection for reprocessing liquid is formed between the first conduit to the second conduit through the first and the second directional control valves and the specified volume. In this state, reprocessing liquid flows through the specified volume and fills it. The specified volume can be part of the flowed through liquid connection of bypass circuit in this state.

In a further embodiment, in a second, preparatory state, the first directional control valve is activated and the second valve inlet of the first directional control valve is subjected to compressed air, causing the specified volume containing reprocessing liquid to partially fill with air. This state can serve to partially empty the specified volume. This state can be maintained for a predetermined amount of time and/or until only a predetermined amount of reprocessing liquid remains in the specified volume. This can serve to provide within the specified volume exactly the required amount of liquid that shall be dosed onto the test surface.

In a third, dosing state, the second directional control valve can be activated and a fluid connection can be formed between the compressed air line to the sample feed line through the first and the second directional control valves and the specified volume. In this state, the dosing out of the amount of reprocessing liquid remaining in the specified volume in the previous, second state via the sample feed line can be prepared and started. The outlet end of the sample feed line can be positioned such that reprocessing liquid flowing out of this outlet end reaches the test surface of a test strip positioned in a dosing position in an arrangement for measuring the concentration of reprocessing agents in a reprocessing apparatus.

In a fourth, drying state, the fluid connection formed between the compressed air line to the sample feed line through the first and the second directional control valves and the specified volume can be drained of reprocessing liquid. In this state, the dosing out of the amount of reprocessing liquid remaining in the specified volume in the previous, second state via the sample feed line can be continued and completed. At the end of this state, the specified volume can be empty and does not contain liquid any more.

According to a further embodiment, in a fifth, continued flow-through state, the first and second directional control valves can be deactivated and a liquid connection for reprocessing liquid can be formed between the first conduit to the second conduit through the first and the second directional control valves and the specified volume. This fifth state can be similar or identical to the first state, where reprocessing liquid flows through the specified volume and fills it. Again, the specified volume can be part of the flowed through liquid connection of bypass circuit in this state.

The reprocessing liquid feed system can be configured to activate the second directional control valve when a predetermined amount of reprocessing fluid is present in the specified volume. This can have the advantage to provide an exact desired or required amount of reprocessing fluid in the specified volume which is to be dosed out.

According to a further embodiment, an arrangement for measuring a concentration of reprocessing agents in a reprocessing liquid used in a reprocessing apparatus for medical instruments is provided. The arrangement comprising a reprocessing liquid feed system as described herein.

According to a further embodiment, a reprocessing apparatus for medical instruments is provided. The reprocessing apparatus comprising a reprocessing chamber; a reprocessing circuit; an arrangement for measuring a concentration of reprocessing agents in a reprocessing liquid as described herein.

According to a further embodiment, a method for dosing a predetermined amount of reprocessing liquid onto a test surface of a test strip is provided. The method comprising filling a specified volume with reprocessing liquid; filling the specified volume containing reprocessing liquid partially with air; dosing out the remaining reprocessing liquid in the specified volume.

Further, the method for dosing can comprise drying the specified volume of reprocessing liquid. The method for dosing can comprise filling a specified volume with reprocessing liquid.

According to an embodiment of the method for dosing, the filling of the specified volume with reprocessing liquid can occur in a first, flow-through state, forming a liquid connection for reprocessing liquid between a first conduit for a hydraulic connection of a measuring system with a reprocessing circuit of a reprocessing apparatus to a second conduit for a bypass connection of the measuring system back into a reprocessing chamber of the reprocessing apparatus through a first and a second directional control valve and a specified volume therebetween, such as by not activating the first and second directional control valves.

In a further embodiment of the method for dosing, the filling of the specified volume containing reprocessing liquid partially with air can occur in a second, preparatory state, such as by activating the first directional control valve and subjecting a second valve outlet of the first directional control valve to compressed air.

Further, the dosing out the remaining reprocessing liquid in the specified volume can occur in a third, dosing state, forming a fluid connection between the compressed air line to the sample feed line through the first and the second directional control valves and the specified volume, such as by activating the second directional control valve.

The drying of the specified volume can occur in a fourth, drying state, and can comprise drying the fluid connection formed between the compressed air line to the sample feed line through the first and the second directional control valves and the specified volume of reprocessing liquid.

Further, the filling of the specified volume with reprocessing liquid can occur in a fifth, continued flow-through state, such as by forming a liquid connection for reprocessing liquid between the first conduit to the second conduit through the first and the second directional control valves and the specified volume, such as by deactivating the first and second directional control valves.

In a further embodiment of the method for dosing, the filling of the specified volume containing reprocessing liquid partially with air can end when a predetermined amount of reprocessing fluid is present in the specified volume.

The dosing out of the remaining reprocessing liquid in the specified volume can start when a predetermined amount of reprocessing fluid is present in the specified volume.

According to a further embodiment, a method for reprocessing medical instruments is provided. The method comprising providing at least one medical instrument in a reprocessing chamber and circulating reprocessing fluid in a reprocessing circuit, such as in a reprocessing apparatus for medical instruments; measuring a concentration of reprocessing agents in a reprocessing liquid used in a reprocessing apparatus for medical instruments; and wherein measuring the concentration of reprocessing agents comprises the steps of the method for dosing a predetermined amount of reprocessing liquid onto a test surface of a test strip as described herein.

As to the advantages, embodiments and details of the individual different embodiments, reference is also made to the corresponding advantages, embodiments and details described with reference to the respective other embodiments. Further embodiments result from the combination of individual, several or all of the features described herein.

### BRIEF DESCRIPTION OF THE DRAWINGS

The embodiments are described with reference to the attached drawings, in which

FIG. 1 illustrates a schematic depiction of an exemplary prior art reprocessing apparatus for medical instruments;

FIG. 2 illustrates a schematic depiction of an exemplary embodiment of a reprocessing apparatus for medical instruments;

FIG. 3 illustrates a schematic depiction of an arrangement for measuring a concentration of reprocessing agents in a reprocessing liquid used in the reprocessing apparatus for medical instruments of FIG. 2 in more detail;

FIG. 4 illustrates a schematic depiction of an exemplary embodiment of a reprocessing liquid feed system;

FIG. 5 illustrates the reprocessing liquid feed system of FIG. 4 in a first state;

FIG. 6 illustrates the reprocessing liquid feed system of FIG. 4 in a second state;

FIG. 7 illustrates the reprocessing liquid feed system of FIG. 4 in a third state;

FIG. 8 illustrates the reprocessing liquid feed system of FIG. 4 in a fourth state;

FIG. 9 illustrates the reprocessing liquid feed system of FIG. 4 in a fifth state;

FIG. 10 illustrates a schematic flow diagram of the method for dosing a predetermined amount of reprocessing liquid onto a test surface of a test strip;

FIG. 11 illustrates a schematic flow diagram of the method for reprocessing medical instruments.

### DETAILED DESCRIPTION

In the figures, elements with the same or comparable functions are indicated with the same reference numerals.

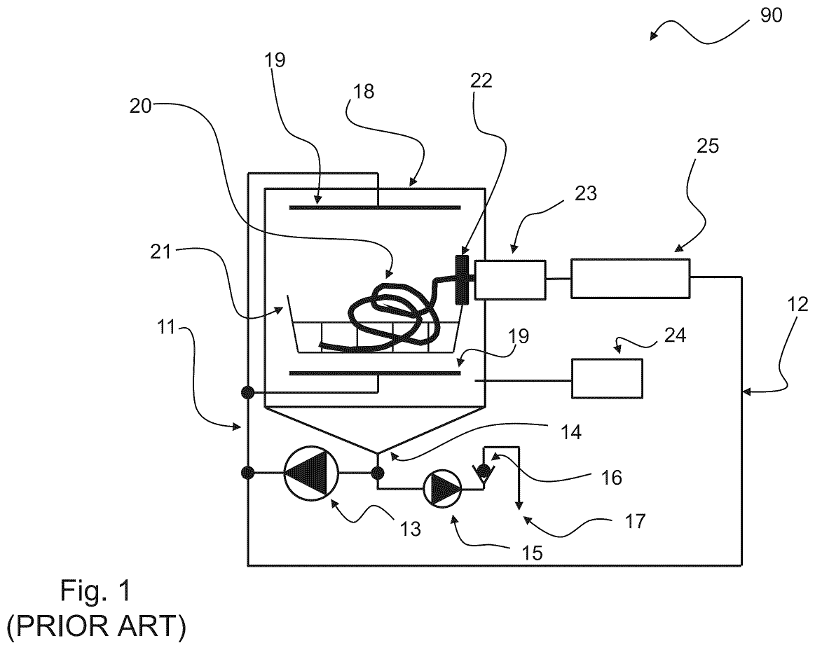

FIG. 1 shows a schematic layout of an exemplary prior art reprocessing apparatus 90 for medical instruments 20, for example endoscopes. The apparatus 90 may comprise a reprocessing chamber 18, in which a loading carrier 21 containing medical instruments 20 to be cleaned and/or disinfected and/or sterilized may be placed. Reprocessing liquid may be circulated in the apparatus 90 via circulation pump 13 and pump sump 14 in an outer reprocessing circuit 11 and an inner reprocessing circuit 12. The outer reprocessing circuit 11 may circulate the reprocessing liquid in the processing chamber 18 via at least one, such as, via two spray arms 19, as shown in FIG. 1. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The monitoring unit can be a “flow control,” which can be a dedicated module that monitors for blockages and dropped adapters. Such monitoring can operate by analyzing pressure differences. The values of which can be communicated via a so-called type list. The monitoring unit therefore also includes sensors, such as pressure sensors.

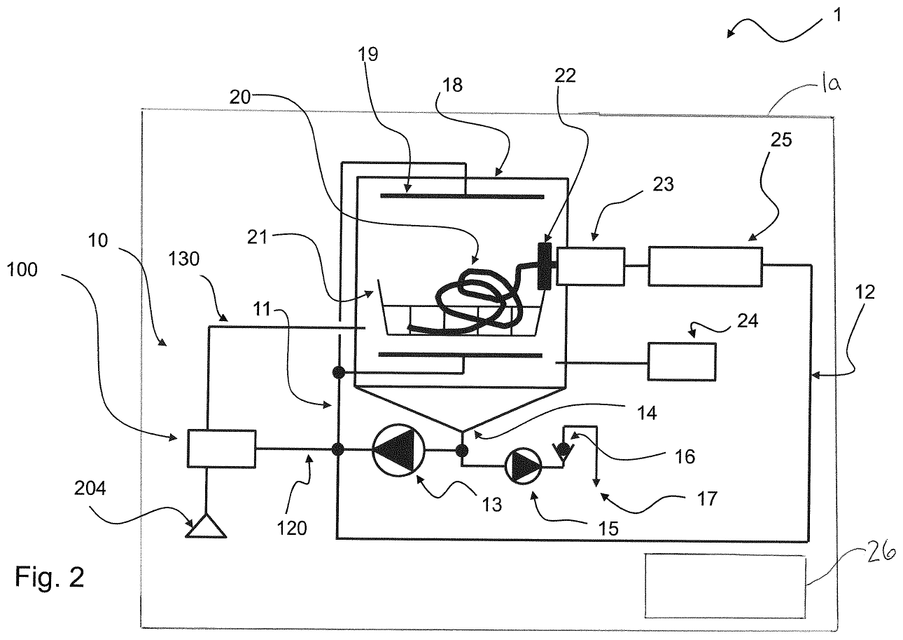

FIG. 2 shows a schematic layout of an exemplary embodiment of a reprocessing apparatus 1 for medical instruments 20, for example endoscopes. The individual components of the reprocessing apparatus 1, as discussed below, can be under the control of a controller 26 for carrying our such reprocessing. Also reprocessing apparatus 1 may comprise a reprocessing chamber 18, in which a loading carrier 21 containing medical instruments 20 to be cleaned and/or disinfected and/or sterilized may be placed. Reprocessing liquid may be circulated in the reprocessing apparatus 1 via circulation pump 13 and pump sump 14 in an outer reprocessing circuit 11 and an inner reprocessing circuit 12. The outer reprocessing circuit 11 may circulate the reprocessing liquid in the processing chamber 18 via least one, such as two spray arms 19. The inner reprocessing circuit 12 may circulate the reprocessing liquid via monitoring unit 25, loading carrier 21 and loading carrier coupling 23 to the inner channels of medical instruments 20 located in loading carrier 21. A dosing system 24 may be provided for dosing reprocessing agents to the reprocessing liquid in the reprocessing chamber 18. Pump sump 14 may be connected to a drain pump 15, which in turn may be connected to a check valve 16 and a structural drain 17.

The inner reprocessing circuit 12 connects the loading carrier 21 to the structural drain 17. The inner reprocessing circuit 12 may comprise a monitoring unit 25, which may be connected to the loading carrier 21 via a loading carrier coupling 23 comprising an adapter plate 22. The monitoring unit 25 may further be connected to the circulation pump 13, and thus to the subsequent elements following the circulation pump, namely the drain pump 15, the check valve 16, and the structural drain 17.

The reprocessing apparatus 1 differs from existing reprocessing apparatus 90 such as in an arrangement (apparatus) 10 for measuring a concentration of reprocessing agents in a reprocessing liquid and a compressed air supply 204.

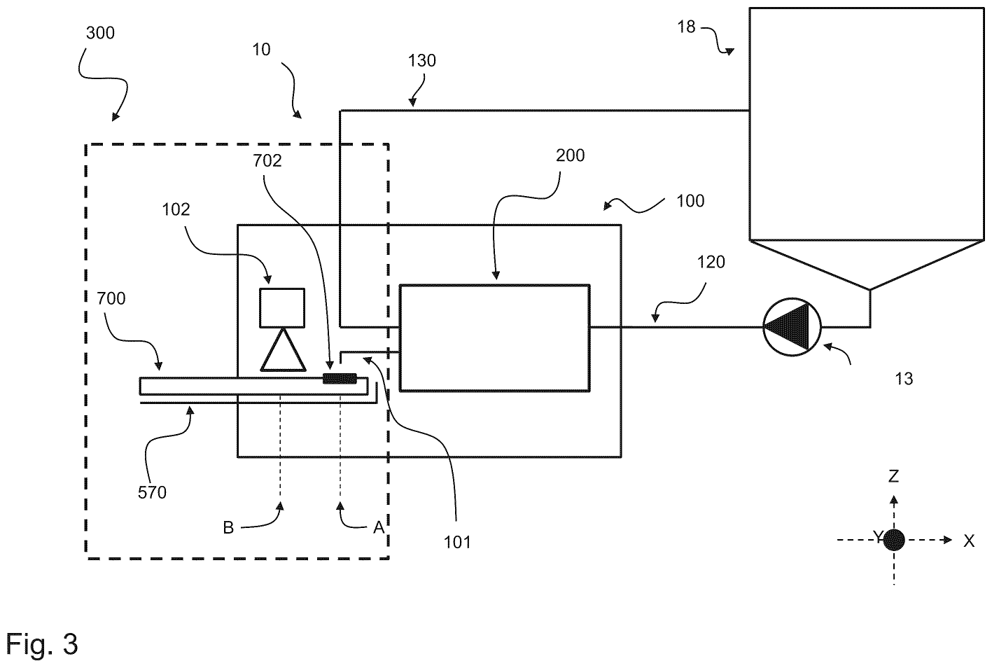

FIG. 3 shows a schematic depiction of an arrangement 10 for measuring a concentration of reprocessing agents in a reprocessing liquid used in the reprocessing apparatus 1 for medical instruments of FIG. 2 in more detail.

The arrangement 10 comprises a measuring system 100 connected to the reprocessing circuits 11, 12, such as to the circulation pump 13, via a first conduit 120 hydraulic connection of the measuring system. Furthermore, the measuring system 100 is connected to the reprocessing chamber 18 via a second conduit 130 for a bypass connection. The first and second conduits can form a bypass circuit for reprocessing liquid to be fed through measuring system 100. The measuring system 100 may be further connected to a compressed air supply 204.

During operation of the apparatus 1, one or several medical instruments 20 are placed into the loading carrier 21 and connected via the adapter plate 22 and the loading carrier coupling 23 to the inner reprocessing circuit 12 for rinsing the inner channel(s) of the medical instrument(s) 20 with reprocessing fluid.

The reprocessing chamber 18 may be filled with reprocessing liquid containing a reprocessing agent using spray arms 19 via the outer reprocessing circuit 11. The reprocessing chamber 18 may hold the reprocessing liquid for a predetermined amount of time. Alternatively and/or additionally, the circulation pump 13 may be used to re-circulate the reprocessing liquid containing the reprocessing agent by pumping it via the circulation pump 13 from the pump sump 14 to the spray arms 19 in the outer reprocessing circuit 11 and/or to the inner channel(s) of the medical instrument(s) 20 in the inner reprocessing circuit 12 for a pre-determined amount of time and/or number of cycles.

During cycling, reprocessing liquid may be taken from the outer reprocessing circuit 11 via the first conduit 120 to supply it to the measuring system 100, in which the concentration of the reprocessing agent in the reprocessing liquid is measured.

Dosing unit 24 may supply additional reprocessing agent according to the measurements of measuring system 100. After measuring the concentration of the reprocessing agent, the remaining reprocessing liquid may be fed back to the outer reprocessing circuit 11 via the second conduit 130.

At the end of a reprocessing procedure, such as after a pre-determined amount of time and/or number of recirculation cycles with a required concentration of reprocessing agents in the reprocessing liquid, the reprocessing chamber 18 may be emptied via the structural drain 17 by using the drain pump 15 for pumping the time liquid through the check valve 16 into the structural drain 17.

The measuring system 100 may be located outside of a housing la of the apparatus 1 or may have an interface on an outer periphery of the apparatus 1.

The measuring system 100 can be configured to receive a test strip 700 with a test surface 702 and to position the test strip 700 in a first, dosing position A and a second, measuring position B, both located along a test strip guide 570, as can be seen in FIG. 3. The measuring system 100 is further configured to dose a predetermined amount of reprocessing liquid onto the test surface 702 when the test strip 700 is positioned in the first, dosing position A via a reprocessing liquid feed system and a sample feed line 101 connected thereto.

The measuring system 100 can comprise an evaluating unit 102 for measuring the concentration of reprocessing agents in the reprocessing liquid when the test strip 700 is positioned in the second, measuring position B by evaluating the test surface 702. The evaluating unit 102 may comprise of an optical spectrometer and/or and RGB color sensor, and the evaluating unit 102 may be configured to compare the evaluation result with a reference value. For example a characteristic, such as a color characteristic, of the test surface 702 may be determined, and compared with a reference characteristic. The predetermined amount of reprocessing liquid may act on the test surface 702 for a predetermined exposure time before evaluating the test surface 702. After evaluating the test surface 702, the test strip 700 is released.

The arrangement 10 for measuring a concentration of reprocessing agents in a reprocessing liquid used in a reprocessing apparatus 1 for medical instruments 20 can further comprise a transport arrangement 300 for transporting a test strip 700. The transport arrangement 300 may be used for transporting a test strip 700. A single test strip 700 can be transported.

The arrangement 10 for measuring a concentration of reprocessing agents in a reprocessing liquid used in a reprocessing apparatus 1 for medical instruments 20 can further comprise a reprocessing liquid feed system 200 for dosing a predetermined amount of reprocessing liquid onto a test surface 702 of a test strip 700.

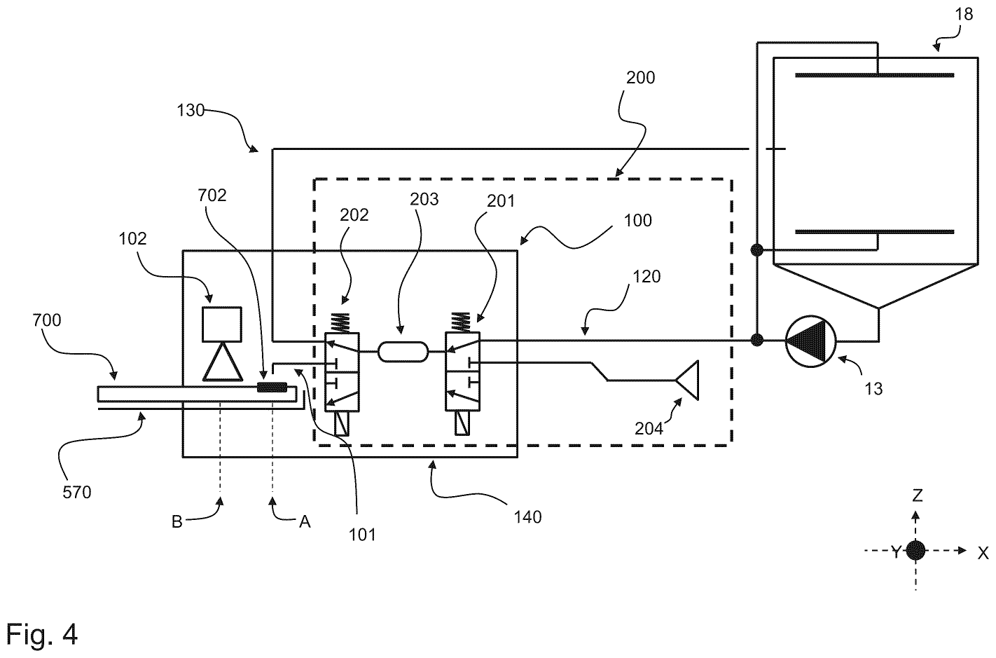

The reprocessing liquid feed system 200 for dosing a predetermined amount of reprocessing liquid onto a test surface 702 of a test strip 700 is shown in more detail in FIGS. 4-9.

The reprocessing liquid feed system 200 comprises a first directional control valve 201 having two valve inlets and one valve outlet and a second directional control valve 202 having one valve inlet and two valve outlets.

As can be seen in FIG. 4, one of the two valve inlets of the first directional control valve 201 is connected to a first conduit 120 for a hydraulic connection of a measuring system 100 with a reprocessing circuit 11, 12 of a reprocessing apparatus 1 and the other one of the two valve inlets of the first directional control valve 201 is connected to a compressed air line connected to a compressed air supply 204 and the valve outlet of the first directional control valve 201 is connected to the valve inlet of the second directional control valve 202.

As can further be seen in FIG. 4, one of the two valve outlets of the second directional control valve 202 is connected to a second conduit 130 for a bypass connection of the measuring system 100 back into a reprocessing chamber 18 of the reprocessing apparatus 1 and the other one of the two valve outlets of the second directional control valve 202 is connected to a sample feed line 101 for dosing a predetermined amount of reprocessing liquid onto a test surface 702 of a test strip 700.

Between the first and the second directional control valves 201, 202 a specified volume 203 is predetermined.

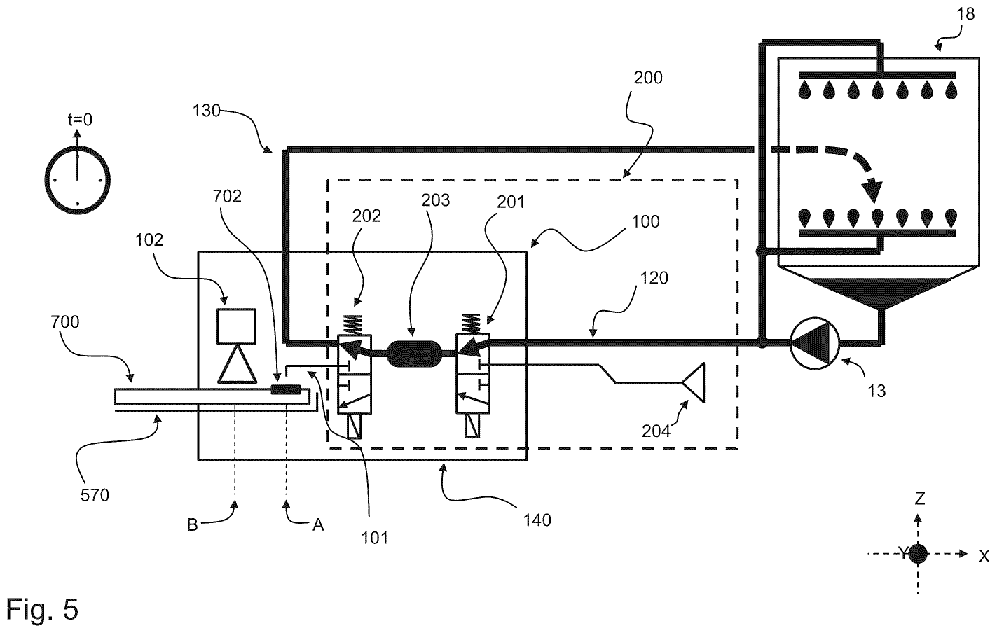

In a first, flow-through state shown in FIG. 5, the first and the second directional control valves 201, 202 are not activated and a liquid connection for reprocessing liquid is formed between the first conduit to the second conduit through the first and the second directional control valves 201, 202 and the specified volume 203.

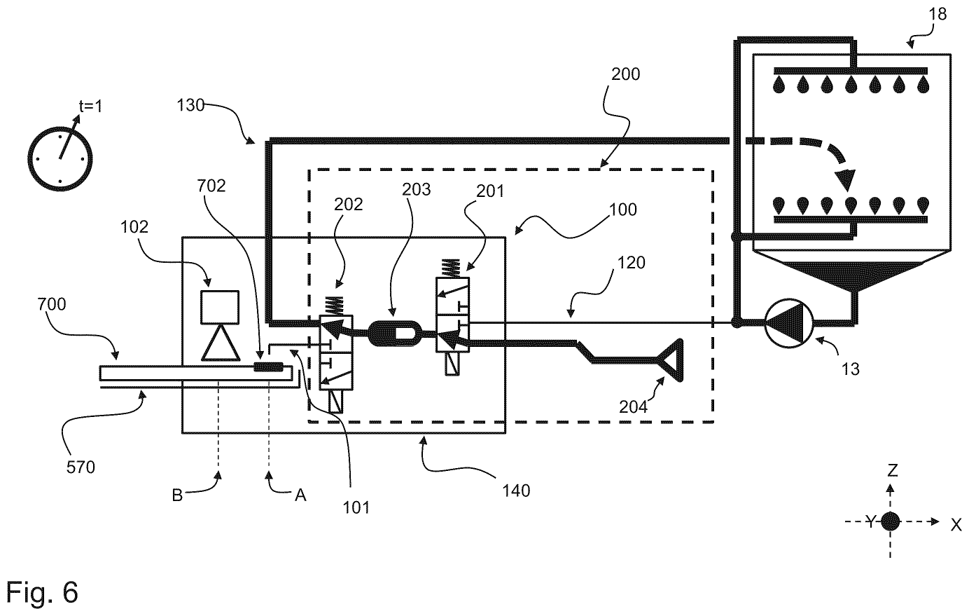

In a second, preparatory state shown in FIG. 6, the first directional control valve 201 is activated and the second valve inlet of the first directional control valve 201 is subjected to compressed air, causing the specified volume 203 containing reprocessing liquid to partially fill with air.

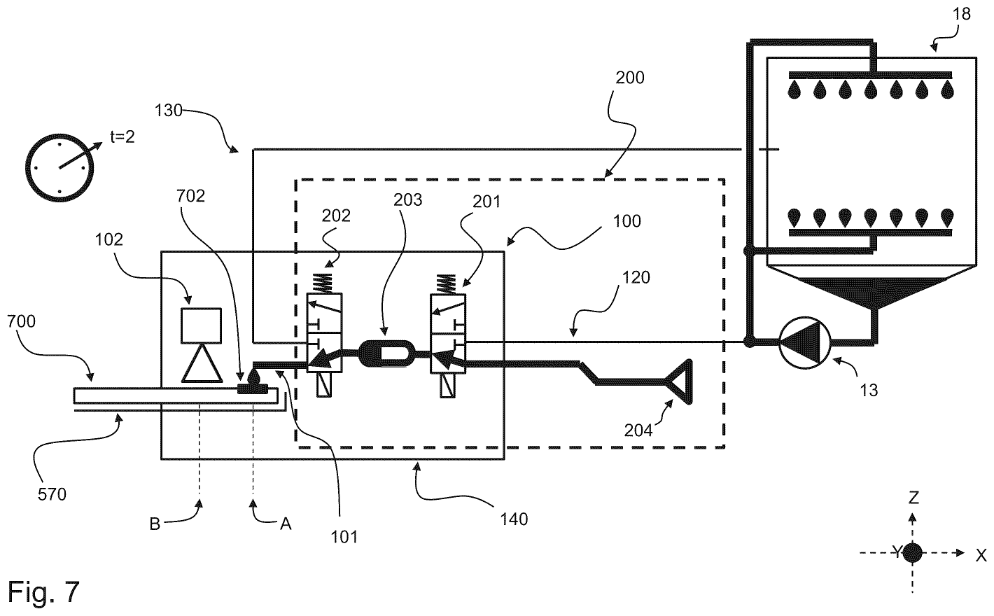

In a third, dosing state shown in FIG. 7, the second directional control valve 202 is activated and a fluid connection is formed between the compressed air line to the sample feed line 101 through the first and the second directional control valves 201, 202 and the specified volume 203.

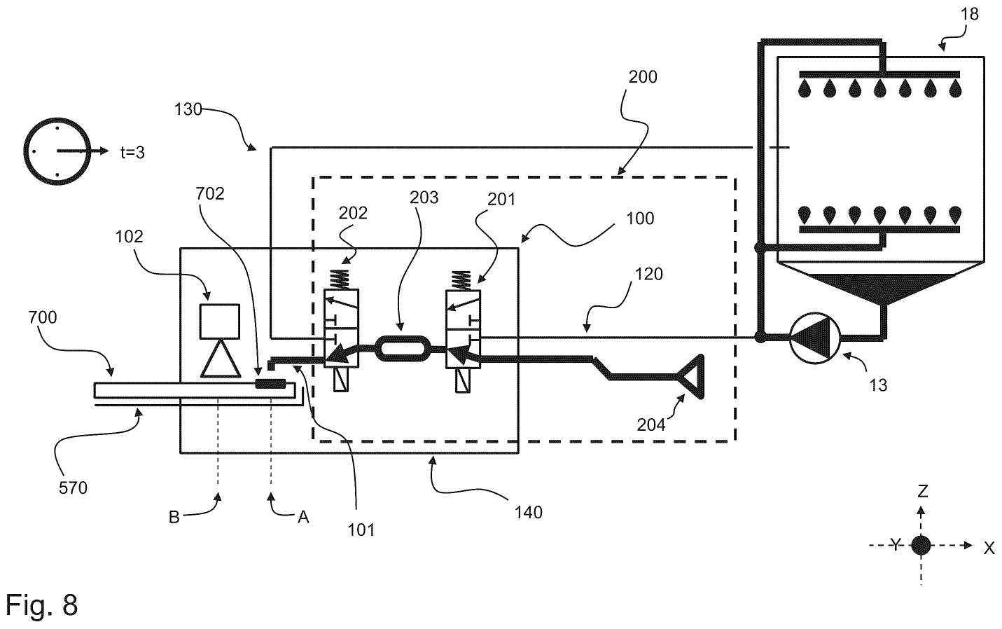

In a fourth, drying state shown in FIG. 8, the fluid connection formed between the compressed air line to the sample feed line 101 through the first and the second directional control valves 201, 202 and the specified volume 203 is drained of reprocessing liquid.

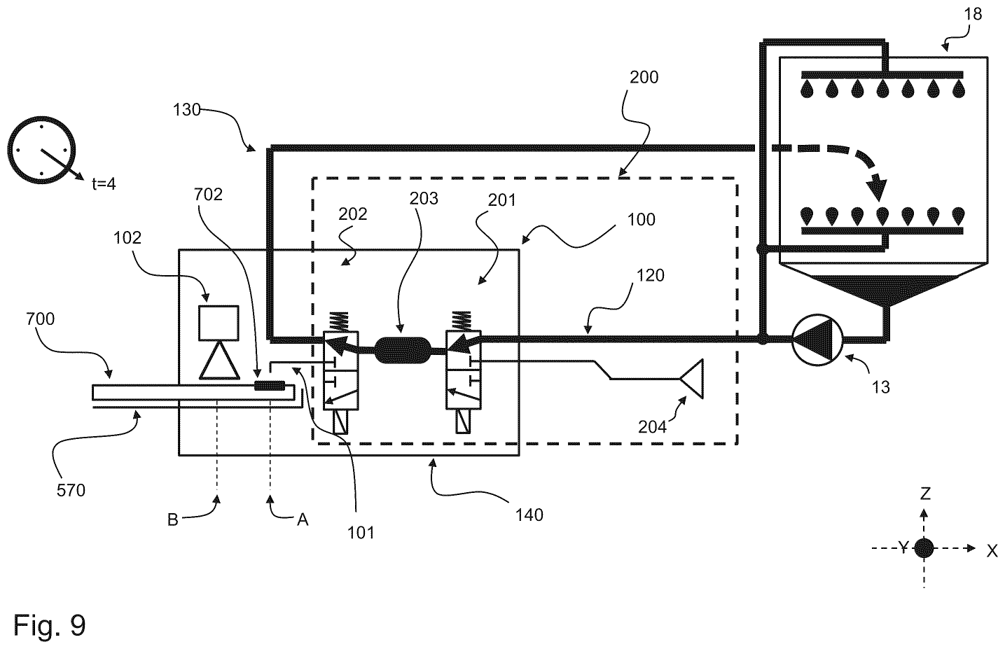

In a fifth, continued flow-through state shown in FIG. 9, the first and second directional control valves 201, 202 are deactivated and a liquid connection for reprocessing liquid is formed between the first conduit to the second conduit through the first and the second directional control valves 201, 202 and the specified volume 203.

Further, the reprocessing liquid feed system 200 is adapted to activate the second directional control valve 202 when a predetermined amount of reprocessing fluid is present in the specified volume 203.

The sequencing of the first and second directional control valves, as well as any other components of the reprocessing liquid feed system 200, to operate in the first to fifth states described above can be carried out by a controller, such as the controller 26 of the reprocessing apparatus or by a separate controller.

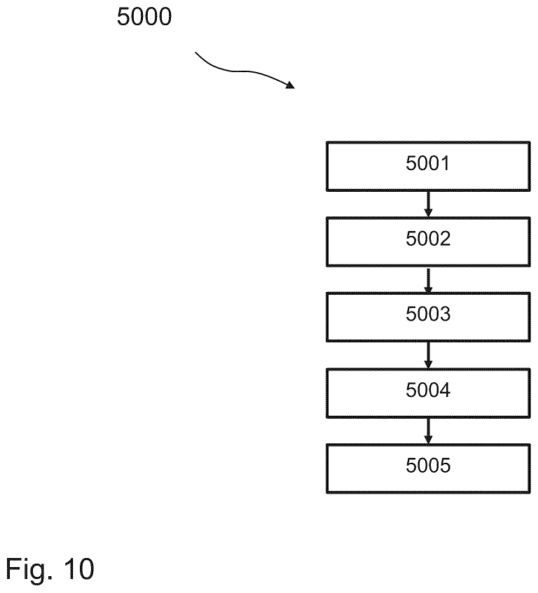

The reprocessing liquid feed system 200 can be used in a method 5000 for dosing a predetermined amount of reprocessing liquid onto a test surface 702 of a test strip 700 shown in FIG. 10. This method 5000 can comprise step 5001 of filling a specified volume 203 with reprocessing liquid; step 5002 of filling the specified volume 203 containing reprocessing liquid partially with air; and step 5003 of dosing out the remaining reprocessing liquid in the specified volume 203.

The method 5000 can further comprise step 5004 of drying the specified volume 203 of reprocessing liquid; and step 5005 of filling a specified volume 203 with reprocessing liquid.

Step 5001 of filling of the specified volume 203 with reprocessing liquid occurs in a first, flow-through state shown in FIG. 5, forming a liquid connection for reprocessing liquid between a first conduit 120 for a hydraulic connection of a measuring system 100 with a reprocessing circuit 11, 12 of a reprocessing apparatus 1 to a second conduit 130 for a bypass connection of the measuring system 100 back into a reprocessing chamber 18 of the reprocessing apparatus 1 through a first and a second directional control valve 201, 202 and a specified volume 203 therebetween, such as by not activating the first and second directional control valves 201, 202.

Step 5002 of filling of the specified volume 203 containing reprocessing liquid partially with air occurs in a second, preparatory state shown in FIG. 6, such as by activating the first directional control valve 201 and subjecting a second valve outlet of the first directional control valve 201 to compressed air.

Step 5003 of dosing out the remaining reprocessing liquid in the specified volume 203 occurs in a third, dosing state shown in FIG. 7, forming a fluid connection between the compressed air line to the sample feed line 101 through the first and the second directional control valves 201, 202 and the specified volume 203, such as by activating the second directional control valve 202.

Step 5004 of drying of the specified volume 203 occurs in a fourth, drying state shown in FIG. 8, and can comprise drying the fluid connection formed between the compressed air line to the sample feed line 101 through the first and the second directional control valves 201, 202 and the specified volume 203 of reprocessing liquid; and/or

Step 5005 of filling of the specified volume 203 with reprocessing liquid occurs in a fifth, continued flow-through state shown in FIG. 9, such as by forming a liquid connection for reprocessing liquid between the first conduit to the second conduit through the first and the second directional control valves 201, 202 and the specified volume 203, such as by deactivating the first and second directional control valves 201, 202.

Step 5002 of filling of the specified volume 203 containing reprocessing liquid partially with air is ended when a predetermined amount of reprocessing fluid is present in the specified volume 203. Step 5003 of dosing out the remaining reprocessing liquid in the specified volume 203 is started when a predetermined amount of reprocessing fluid is present in the specified volume 203.

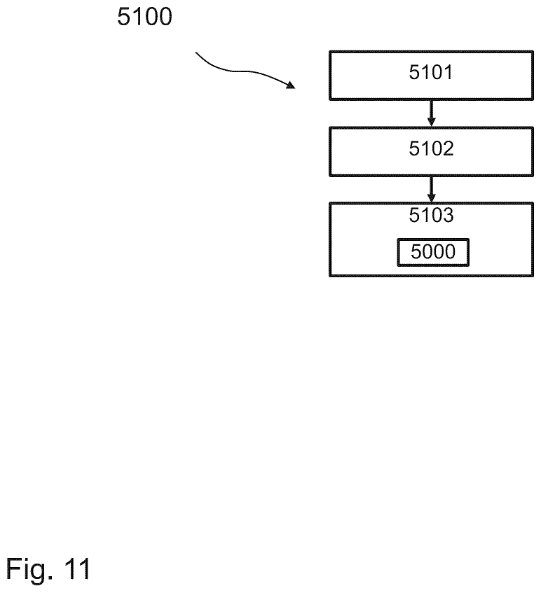

The method 5000 for dosing a predetermined amount of reprocessing liquid onto a test surface 702 of a test strip 700 can be part of a method 5100 for reprocessing medical instruments 20 shown in FIG. 11. The method 5100 for reprocessing medical instruments 20 comprises step 5101 of providing at least one medical instrument 20 in a reprocessing chamber 18 and step 5102 of circulating reprocessing fluid in a reprocessing circuit 11, 12, such as in a reprocessing apparatus 1 for medical instruments 20. Further, the method 5100 for reprocessing medical instruments 20 comprises step 5103 of measuring a concentration of reprocessing agents in a reprocessing liquid used in a reprocessing apparatus 1 for medical instruments 20. The step 5103 of measuring the concentration of reprocessing agents comprises the steps of the method 5000 for dosing a predetermined amount of reprocessing liquid onto a test surface 702 of a test strip 700 as previously described.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A reprocessing liquid feed system for dosing a predetermined amount of reprocessing liquid onto a test surface of a test strip, the reprocessing liquid feed system comprising:
a first directional control valve having two valve inlets and one valve outlet; and
a second directional control valve having one valve inlet and two valve outlets;
wherein one of the two valve inlets of the first directional control valve is connected to a first conduit for a hydraulic connection of a measuring system with a reprocessing circuit of a reprocessing apparatus and an other one of the two valve inlets of the first directional control valve is connected to a compressed air line configured to be connected to a compressed air supply, and the valve outlet of the first directional control valve is connected to the valve inlet of the second directional control valve;
one of the two valve outlets of the second directional control valve is connected to a second conduit for a bypass connection of the measuring system into a reprocessing chamber of the reprocessing apparatus and an other one of the two valve outlets of the second directional control valve is connected to a sample feed line for dosing the predetermined amount of reprocessing liquid onto the test surface of the test strip; and
a specified volume is defined between the first and the second directional control valves.

2. The reprocessing liquid feed system according to claim 1, wherein in a first, flow-through state, the first and the second directional control valves are not activated and a liquid connection for reprocessing liquid is formed between the first conduit to the second conduit through the first and the second directional control valves and the specified volume.

3. The reprocessing liquid feed system according to claim 2, wherein in a second, preparatory state, the first directional control valve is activated and the second valve inlet of the first directional control valve is subjected to compressed air, causing the specified volume containing reprocessing liquid to partially fill with air.

4. The reprocessing liquid feed system according to claim 3, wherein in a third, dosing state, the second directional control valve is activated and a fluid connection is formed between the compressed air line to the sample feed line through the first and the second directional control valves and the specified volume.

5. The reprocessing liquid feed system according to claim 4, wherein in a fourth, drying state, the fluid connection formed between the compressed air line to the sample feed line through the first and the second directional control valves and the specified volume is drained of reprocessing liquid.

6. The reprocessing liquid feed system according to claim 5, wherein in a fifth, continued flow-through state, the first and second directional control valves are deactivated and a liquid connection for reprocessing liquid is formed between the first conduit to the second conduit through the first and the second directional control valves and the specified volume.

7. The reprocessing liquid feed system according to claim 1, wherein the second directional control valve is activated when a predetermined amount of reprocessing fluid is present in the specified volume.

8. A measuring apparatus for measuring a concentration of reprocessing agents in a reprocessing liquid used in a reprocessing apparatus for medical instruments, the measuring apparatus comprising the reprocessing liquid feed system according to claim 1.

9. A reprocessing apparatus for medical instruments, the reprocessing apparatus comprising:
a reprocessing chamber;
a reprocessing circuit; and
the measuring apparatus according to claim 8.

10. A method for dosing a predetermined amount of reprocessing liquid onto a test surface of a test strip, the method comprising:
filling a specified volume with reprocessing liquid;
filling the specified volume containing reprocessing liquid partially with air such that the specified volume is filled partially with remaining reprocessing liquid and partially with air; and
dosing out the remaining reprocessing liquid in the specified volume.

11. The method for dosing according to claim 10, further comprising, subsequent to the dosing out, drying the specified volume of reprocessing liquid.

12. The method for dosing according to claim 11, further comprising, subsequent to the drying, filling the specified volume with reprocessing liquid.

13. The method for dosing according to claim 12, wherein one or more of:
the filling of the specified volume with reprocessing liquid occurs in a first, flow-through state, forming a liquid connection for reprocessing liquid between a first conduit for a hydraulic connection of a measuring system with a reprocessing circuit of a reprocessing apparatus to a second conduit for a bypass connection of the measuring system into a reprocessing chamber of the reprocessing apparatus through a first and a second directional control and a specified volume therebetween;
the filling of the specified volume containing reprocessing liquid partially with air occurs in a second, preparatory state;
the dosing out of the remaining reprocessing liquid in the specified volume occurs in a third, dosing state, forming a fluid connection between the compressed air line to the sample feed line through the first and the second directional control valves and the specified volume;
the drying of the specified volume occurs in a fourth, drying state; and
the filling of the specified volume with reprocessing liquid occurs in a fifth, continued flow-through state.

14. The method for dosing according to claim 13, wherein the filling in the first, flow-through state occurs by not activating the first and second directional control valves.

15. The method for dosing according to claim 13, wherein the filling in the second, flow-through state occurs by activating the first directional control valve and subjecting a second valve outlet of the first directional control valve to compressed air.

16. The method for dosing according to claim 13, wherein the dosing out in the third, flow-through state occurs by activating the second directional control valve.

17. The method for dosing according to claim 13, wherein the drying in the fourth, flow-through state comprises drying the fluid connection formed between the compressed air line to the sample feed line through the first and the second directional control valves and the specified volume of reprocessing liquid.

18. The method for dosing according to claim 13, wherein the filling in the fifth, flow-through state occurs by forming a liquid connection for reprocessing liquid between the first conduit to the second conduit through the first and the second directional control valves and the specified volume, by deactivating the first and second directional control valves.

19. The method for dosing according to claim 10, wherein one or more of:
the filling of the specified volume containing reprocessing liquid partially with air is ended when the predetermined amount of reprocessing fluid is present in the specified volume; and
the dosing out of the remaining reprocessing liquid in the specified volume is started when the predetermined amount of reprocessing fluid is present in the specified volume.

20. A method for reprocessing medical instruments, the method comprising:
providing at least one medical instrument in a reprocessing chamber and circulating reprocessing fluid in a reprocessing circuit; and
measuring a concentration of reprocessing agents in the reprocessing liquid;
wherein the measuring of the concentration of the reprocessing agents comprises the method for dosing a predetermined amount of reprocessing liquid according to claim 10.
